(19) United States
(12) Patent Application Publication
(10) Pub. No.: US 2011/0235257 A1
(43) Pub. Date: Sep. 29, 2011

(54) SUPPORT MECHANISM AND DISPLAY DEVICE USING THE SAME

(75) Inventors: HUNG-CHOU CHAN, TU-CHENG (TW); ZHEN-XING YE, SHENZHEN CITY (CN)

(73) Assignees: HONG FU JIN PRECISION INDUSTRY (SHENZHEN) CO., LTD, SHENZHEN CITY (CN); HON HAI PRECISION INDUSTRY CO., LTD., TU-CHENG (TW)

(21) Appl. No.: 12/915,246

(22) Filed: Oct. 29, 2010

(30) Foreign Application Priority Data
Mar. 29, 2010 (CN) 201010134673.8

(51) Int. Cl. G06F 1/16; F16M 11/12

(52) U.S. Cl. 361/679.21; 248/121

(57) ABSTRACT

A support mechanism includes a base, a first connection member connected to one side of the base, a rotation assembly connected to the other side of the base, and a second connection member rotatably connected to the rotation assembly. The rotation assembly includes a first hinged member and a second hinged member. The first hinged member includes a pivot shaft, and the second hinged member forms an engaging portion in which the pivot shaft is rotatably received. The first hinged member is rotatably connected to the base, and the second hinged member is rotatably connected with the second connection member. The disclosure further provides a display device using the support mechanism.

### BACKGROUND

1. Technical Field

The present disclosure generally relates to support mechanisms, and more particularly to a support mechanism applied to a display device.

2. Description of Related Art

Multiple screens are generally applied to a display device to facilitate users working on different screens independently, or observing a single computer from different positions at the same time. The screens are further rotatable to predetermined angles for the users to observe them from different view points.

A support mechanism of a display device includes a support frame and two gimbals positioned on two sides of the support frame. Each gimbal includes a number of elements working cooperatively. Two screens are respectively fixed on the gimbals. In use, the screens rotate through different angles with the cooperation of the elements of the gimbals, as such there are too many elements being employed. Therefore, the support mechanism has a complex structure, which is difficult and expensive to produce.

Therefore, there is room for improvement within the art.

### BRIEF DESCRIPTION OF THE DRAWINGS

The components in the drawings are not necessarily drawn to scale, the emphasis being placed upon clearly illustrating the principles of the present disclosure. Moreover, in the drawings, like reference numerals designate corresponding parts throughout several views, and all the views are schematic.

FIG. 1 is an assembled, isometric view of one embodiment of a display device including a support mechanism, shown in one state.

FIG. 2 is an assembled, isometric view of the support mechanism of FIG. 1.

FIG. 3 is an exploded, isometric view of the support mechanism of FIG. 1.

FIG. 4 is similar to FIG. 3, but viewed from another aspect.

FIG. 5 is the display device of FIG. 1, shown in another state.

FIG. 6 is the display device of FIG. 1, shown in yet another state.

### DETAILED DESCRIPTION

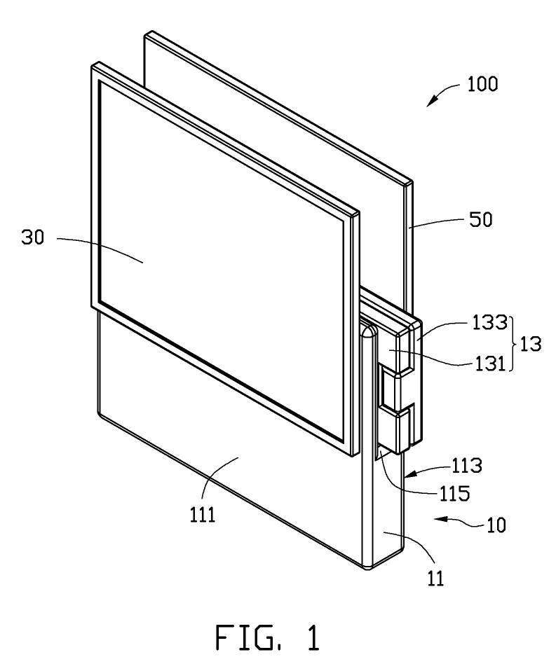

Referring to FIG. 1, a display device 100 includes a support mechanism 10, a first screen 30, and a second screen 50. The first screen 30 and the second screen 50 are connected to the support mechanism 10.

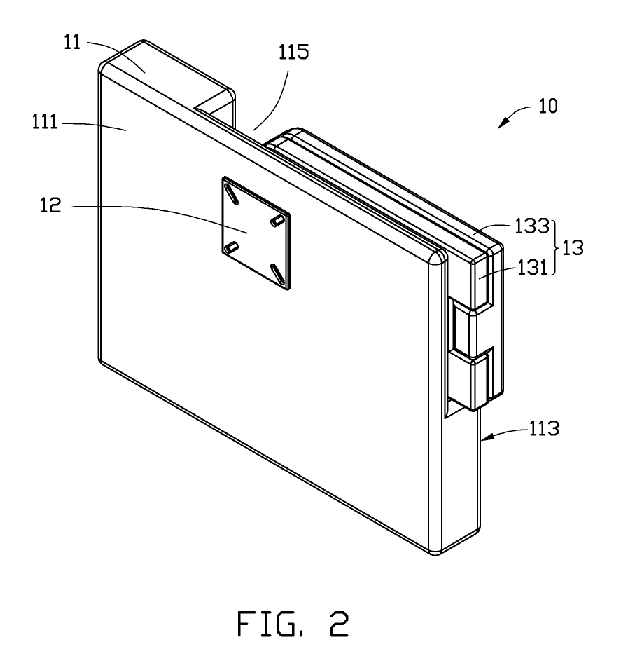

Referring to FIGS. 2 through 4, the support mechanism 10 includes a base 11, a first connection member 12 rotatably connected to one side of the base 11, a rotation assembly 13 rotatably connected to the other side of the base 11, and a second connection member 14 rotatably connected to the rotation member 13.

The base 11 includes a first side surface 111 and a second side surface 113 opposite to the first side surface 111. The base 11 defines a receiving space 115 and a shaft hole 117 communicating with the receiving space 115. The receiving space 115 recesses from the second side surface 113 to the first side surface 111 and the shaft hole 117 recesses from the first side surface 111 to the receiving space 115.

The first connection member 12 includes a fixing portion 121 and a pivotable portion 123 connected to the fixing portion 121. The fixing portion 121 is a plate and defines a number of elongated holes 1211. The pivotable portion 123 is substantially cylindrical. In the illustrated embodiment, the fixing portion 121 defines four elongated holes 1211 around the pivotable portion 123. Alternatively, the fixing portion 121 can be a block and may define any other numbers of elongated holes 1211.

The rotation assembly 13 includes a first hinged member 131 and a second hinged member 133 rotatably connected to the first hinged member 131.

The first hinged member 131 includes a main body 1311, a pivot shaft 1313 positioned at an end of the main body 1311, and a connection pole 1315 formed on the main body 1311. The main body 1311 defines a slot 1316 recessing from the end where the pivot shaft 1313 is positioned and two assembly portions 1317 on two sides of the slot 1316. The pivot shaft 1313 passes through the assembly portions 1317 and is partially received in the slot 1316. The connection pole 1315 protrudes from one side of the main body 1311.

The second hinged member 133 includes a main body 1331 and an engaging portion 1333 protruding from one end of the main body 1331. The main body 1331 defines a receiving hole 1335 therein. The engaging portion 1333 is substantially rectangular and defines a through hole 1336 for the pivot shaft 1313 of the first hinged member 131 passing through. The engaging portion 1333 forms a rounded corner (not labeled) at each edge thereof. In the illustrated embodiment, the receiving hole 1335 is blind, and it can be a through hole instead. The engaging portion 1333 can also be columned. Alternatively, the second hinged member 133 may be rotatably connected to the base 11, and the second connection member 14 is rotatably connected to the hinged member 131.

The structure of the second connection member 14 is similar to that of the first connection member 12, and includes a fixing portion 141 and a pivotable portion 143. The fixing portion 141 is a plate and defines a number of elongated holes 1411 therein. In the illustrated embodiment, the fixing portion 141 defines four elongated holes 1411. Alternatively, the fixing portion 141 can be a block and define any other numbers of elongated holes 1411.

The first screen 30 and the second screen 50 are liquid crystal displays in the illustrated embodiment.

During assembly of the display device 100, the engaging portion 1333 of the second hinged member 133 is received in the slot 1316 in the main body 1311 of the first hinged member 131. The pivot shaft 1313 passes through one assembly portion 1317 of the main body 1311 of the first hinged member 131, the through hole 1336 in the engaging portion 1333 of the second hinged member 133, and the other assembly portion 1317 of the first hinged member 131. The pivot shaft 1313 engages with the assembly portions 1317 by interference fit, and thereby the pivot shaft 1313 is non-rotatable relative to the main body 1311 of the first hinged member 131. The engaging portion 1333 is rotatably sleeved on the pivot shaft 1313, and therefore the second hinged member 133 is rotatable relative to the first hinged member 131 around the pivot shaft 1313.

The connection pole 1315 of the first hinged member 131 of the rotation assembly 13 is inserted into the shaft hole 117 in the base 11 from one side thereof and rotates relative to the base 11. The pivotable portion 123 of the first connection member 12 is rotatably inserted into the shaft hole 117 from the other side of the base 11, and the pivotable portion 143 of the second connection member 14 is rotatably inserted into the receiving hole 1335 in the second hinged member 133 of the rotation assembly 13. The first screen 30 is connected to the first connection member 12, and the second screen 50 is connected to the second connection member 14. Therefore, the display device 100 is assembled.

In use, the second screen 50 rotates to different positions and angles relative to the first screen 30. The first screen 30 connected to the first connection member 12 is rotatable relative to the base 11. Referring to FIG. 1 again, when the second hinged member 133 is manually rotated to overlap the first hinged member 131 of the rotation assembly 13, the rotation assembly 13 is received in the receiving space 115 in the base 11. In addition, a total thickness of the first and the second hinged members 131, 133 is substantially equal to the depth of the receiving space 115, the distance from the bottom surface which is substantially parallel to the second side surface 111 of the base to the second side surface 113 of the base 11. Therefore, one side surface (not labeled) of the second hinged member 133 away from the first hinged member 131 is coherent with the second side surface 113 of the base 11. In this state, the first screen 30 and the second screen 50 are held on opposite sides of the support mechanism 10.

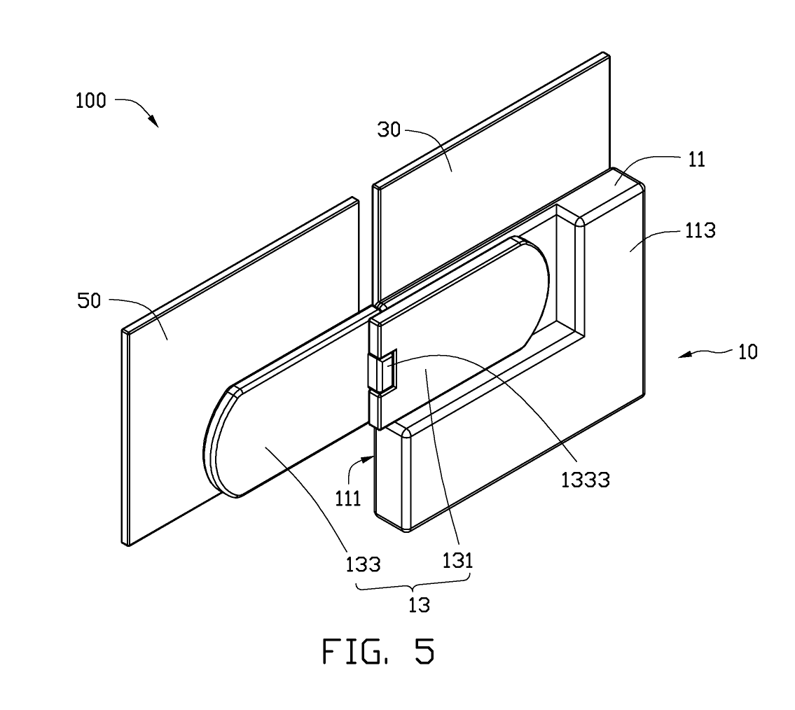

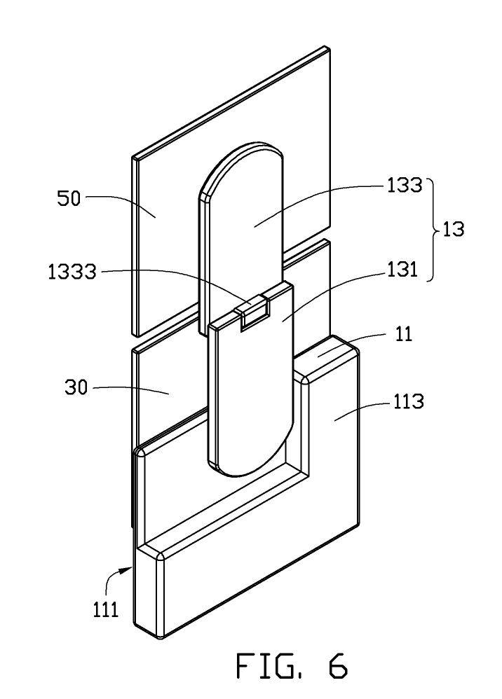

Referring to FIGS. 5 and 6, when the second hinged member 133 of the rotation assembly 13 is manually rotated to be unfolded with the first hinged member 131, the first screen 30 and the second screen 50 are held abreast. After the second hinged member 133 is manually rotated a further 90 degrees relative to the first hinged member 131, the second screen 50 is rotated to the top of the first screen 30, such that the first screen 30 and the second screen 50 are positioned in a longitudinal direction. The second screen 50 is rotated 90 degrees relative to the second hinged member 133, and thereby, the data shown on the first screen 30 and the second screen 50 is in the same direction, as shown in FIG. 6.

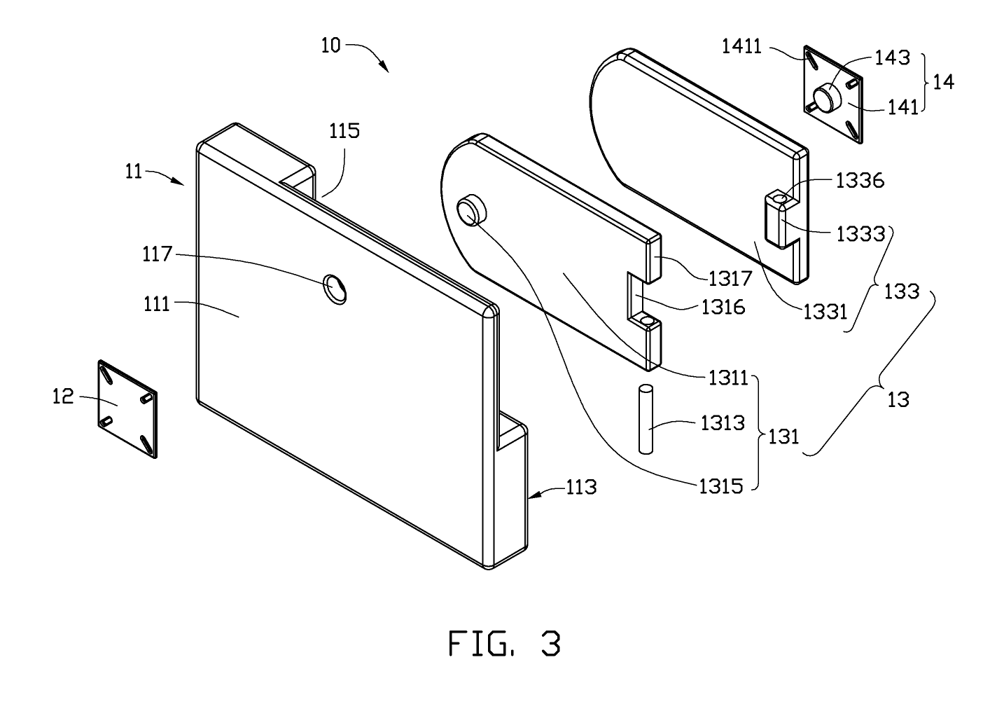

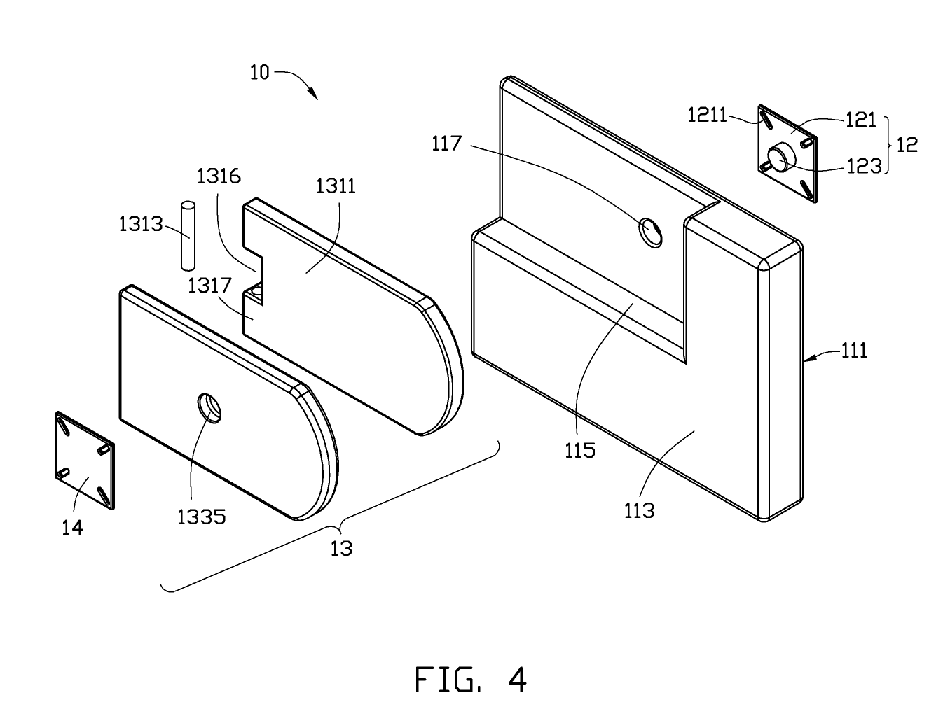

Also referring to FIGS. 3 and 4, in the display device 100, the second screen 50 rotates through multiple angles relative to the first screen 30 with the rotatable connection between the first hinged member 131 and the second hinged member 133 and the rotatable connection between the rotation assembly 30 and the base 10. There, the display device 100 meets different demands. In the support mechanism 10, the first connection member 12 is rotatably connected to the base 11 with the pivotable portion 123. The first hinged member 131 and the second hinged member 133 are rotatably connected with the pivot shaft 1313, the rotation assembly 13 is rotatably connected to the base 11 with the connection pole 1315, and the second connection member 14 is rotatably connected to the rotation assembly 13 with the pivotable portion 143. Therefore, the first connection member 12 rotates relative to the base 11, the rotation assembly 13 rotates relative to the base 11, and the second connection member 14 rotates relative to the rotation assembly 13. The support mechanism 10 is simple, easily produced, and has a low cost.

In the rotation assembly 13, the first hinged member 131 define the slot 1316 at an end thereof, and the second hinged member 133 forms the engaging portion 1333 at the end of thereof. Thus the second hinged member 133 completely unfolds relative to the first hinged member 131. Additionally, since the engaging portion 1333 is formed at one side of the end of the main body 1331, the second hinged member 133 rotates to totally overlap the first hinged member 131.

The engaging portion 1333 of the second hinged member 133 forms the rounded corner at each edge thereof, such that the engaging portion 1333 rotates in the slot 1316 of the main body 1311 of the first hinged member 131 and is never blocked by inner side walls (not labeled) of the slot 1316. In addition, the engaging portion 1333 is rectangular, and therefore, the side surfaces (not labeled) thereof are coherent with the side surfaces (not labeled) of the main body 1331 of the second hinged member 133, facilitating users to orientate. Specifically, where the engaging portion 1333 forms the rounded corner at each edge, a relatively large friction is generated when each edge of the engaging portion 1333 passes by the inner side walls of the slot 1316 in the first hinged member 131. Therefore, the engaging portion 1333 rotates substantially 90 degrees when a force large enough is forced thereon. Thus the engaging portion 1333 automatically orientates and the user can get a good handle.

The elongated holes 1211 in the first connection member 12 and the elongated holes 1411 in the second connection member 14 are for the first screen 30 and the second screen 50 to be conveniently adjusted with during assembly.

The main body 1331 of the second hinged member 133 are plates, such that a contact area between the second screen 50 and the second hinged member 133 is large enough to hold the second screen 50 steadily.

Alternatively, the base 11 may form two pivot shafts on opposite sides, and each of the first connection member 12 and the main body 1311 of the first hinged member 131 defines a hole for receiving the pivot shafts of the base 11. The first connection member 12 may be fixed on the base 11 instead.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A support mechanism, comprising:
a base;
a first connection member connected to one side of the base;
a second connection member; and
a rotation assembly connected to the other side of the base, the rotation assembly comprising a first hinged member and a second hinged member, the first hinged member comprising a pivot shaft and the second hinged member forming an engaging portion engaging with the pivot shaft, wherein one of the first hinged member and the second hinged member is rotatably connected to the base, and the other one of the first hinged member and the second hinged member is rotatably connected with the second connection member.

2. The support mechanism of claim 1, wherein the pivot shaft is positioned at one end of the first hinged member, and the engaging portion is formed at one end of the second hinged member.

3. The support mechanism of claim 2, wherein the engaging portion is formed on one side of the end of the second hinged member.

4. The support mechanism of claim 2, wherein the engaging portion is substantially rectangular and each edge of the engaging portion defines a rounded corner.

5. The support mechanism of claim 1, wherein the first hinged member comprises a main body and the second hinged member comprises a main body, and the main bodies of the first hinged member and the second hinged member are plates.

6. The support mechanism of claim 1, wherein the first hinged member forms a connection pole and the base defines a shaft hole in which the connection pole is rotatably received.

7. The support mechanism of claim 6, wherein the first connection member comprises a fixing portion and a pivotable portion on the fixing portion, the pivotable portion being rotatably received in the shaft hole in the base.

8. The support mechanism of claim 7, wherein the fixing portion of the first connection member defines at least one elongated hole.

9. The support mechanism of claim 1, wherein the second connection member comprises a fixing portion and a pivotable portion on the fixing portion, and one of the first hinged member and the second hinged member connected with the second connection member defines a receiving hole in which the pivotable portion is rotatably received.

10. The support mechanism of claim 9, wherein the fixing portion of the second connection portion defines at least one elongated hole.

11. The support mechanism of claim 1, wherein the base defines a receiving space, and a total thickness of the first hinged member and the second hinged member is substantially equal to a depth of the receiving space.

12. A display device, comprising:
a support mechanism comprising:
a base;
a first connection member connected to one side of the base;
a second connection member; and
a rotation assembly connected to the other side of the base, the rotation assembly comprising a first hinged member and a second hinged member, the first hinged member comprising a pivot shaft and a second hinged member forming an engaging member engaging with the pivot shaft, wherein one of the first hinged member and the second hinged member is rotatably connected to the base, and the other one of the first hinged member and the second hinged member is rotatably connected with the second connection member;
a first screen fixed on the first connection member; and
a second screen fixed on the second connection member.

13. The display device of claim 12, wherein the pivot shaft is positioned at one end of the first hinged member, and the engaging portion is formed at one end of the second hinged member.

14. The display device of claim 13, wherein the engaging portion is formed on one side of the end of the second hinged member.

15. The display device of claim 13, wherein the engaging portion is substantially rectangular and each edge of the engaging portion defines a rounded corner.

16. The display device of claim 12, wherein the first hinged member comprises a main body and the second hinged member comprises a main body, and the main bodies of the first hinged member and the second hinged member are plates.

17. The display device of claim 12, wherein the first hinged member forms a connection pole, and the base defines a shaft hole in which the connection pole is rotatably received.

18. The display device of claim 17, wherein the first connection member comprises a fixing portion and a pivotable portion on the fixing portion, the pivotable portion being rotatably received in the shaft hole in the base.

19. The display device of claim 12, wherein the second connection member comprises a fixing portion and a pivotable portion on the fixing portion, and one of the first hinged member and the second hinged member connected with the second connection member defines a receiving hole in which the pivotable portion is rotatably received.

20. The display device of claim 12, wherein the base defines a receiving space, and a total thickness of the first hinged member and the second hinged member is substantially equal to a depth of the receiving space.
